(19) United States
(12) Patent Application Publication
(10) Pub. No.: US 2026/0161226 A1
(43) Pub. Date: Jun. 11, 2026

(54) PREDICTIVE EXTENDED REALITY SYSTEM

(71) Applicant: Telefonaktiebolaget LM Ericsson (publ), Stockholm (SE)

(72) Inventors: Giuseppe BURGARELLA, Santa Clara, CA (US); Ho Thanh Thao NGUYEN, Marina del Rey, CA (US)

(73) Assignee: Telefonaktiebolaget LM Ericsson (publ), Stockholm (SE)

(21) Appl. No.: 18/706,377

(22) PCT Filed: Nov. 11, 2021
(86) PCT No.: PCT/IB2021/060471

§ 371 Date: Apr. 30, 2024

(51) Int. Cl. G06F 3/01; G06T 3/4092; G06T 7/207; G06T 7/246; G06T 7/73; G06T 11/00

(52) U.S. Cl. CPC G06F 3/015; G06T 3/4092; G06T 7/207; G06T 7/248; G06T 7/74; G06T 11/00; G06T 2207/30201

(57) ABSTRACT

A method of an extended reality (XR) application executed at a server. The method includes receiving brain machine interface (BMI) data encoding brain signaling metrics from an XR device, receiving position data from the XR device, computing a pose prediction for a future time frame for the XR device using the BMI data and the position data, computing an XR pre-frame for the future time frame using the pose prediction, and sending the XR pre-frame to the XR device.

### TECHNICAL FIELD

Embodiments of the invention relate to the field of extended reality systems; and more specifically, to methods and system for predicting extended reality headset movements to improve the responsiveness of extended reality experiences to users.

### BACKGROUND ART

Augmented reality (AR) augments the real world and the physical objects in the real world by overlaying virtual content. This virtual content is often produced digitally and may incorporate sound, graphics, and video. For example, a shopper wearing augmented reality glasses while shopping in a supermarket might see nutritional information for each object as they place it in their shopping cart. The glasses augment reality with information.

Virtual reality (VR) uses digital technology to create an entirely simulated environment. Unlike AR, which augments reality, VR immerses users inside an entirely simulated experience. In a fully VR experience, all visuals and sounds are produced digitally and do not include input from the user's actual physical environment. For example, VR may be integrated into manufacturing where trainees practice building machinery in a virtual reality before starting on the real production line.

Mixed reality (MR) combines elements of both AR and VR. In the same vein as AR, MR environments overlay digital effects on top of the user's physical environment. MR also integrates additional, richer information about the user's physical environment such as depth, dimensionality, and surface textures. In MR environments, the end user experience more closely resembles the real world. As an example, consider two users hitting a MR tennis ball on a real-world tennis court. MR incorporates information about the hardness of the surface (grass versus clay), the direction and force the racket struck the ball, and the players' height. Augmented reality and mixed reality are often used to refer to the same idea. As used herein, “augmented reality” also refers to mixed reality.

Extended reality (XR) is an umbrella term referring to all real-and-virtual combined environments, such as AR, VR and MR. XR refers to a wide variety and vast number of levels in the reality-virtuality continuum of the perceived environment, consolidating AR, VR, MR and other types of environments (e.g., augmented virtuality, mediated reality, etc.) under one term.

An XR device is the device used as an interface for the user to perceive both virtual and/or real content in the context of extended reality. An XR device typically has a display that may be opaque and displays both the environment (real or virtual) and virtual content together (i.e., video see-through) or overlay virtual content through a semi-transparent display (optical see-through). The XR device may acquire information about the environment through the use of sensors (typically cameras and inertial sensors) to map the environment while simultaneously tracking the device's location within the environment.

### SUMMARY

The embodiments include a method of an extended reality (XR) application executed at a server. The method includes receiving brain machine interface (BMI) data encoding brain signaling metrics from an XR device, receiving position data from the XR device, computing a pose prediction for a future time frame for the XR device using the BMI data and the position data, computing an XR pre-frame for the future time frame using the pose prediction, and sending the XR pre-frame to the XR device.

In another embodiment, a method of an XR device includes sending BMI data encoding brain signaling metrics to a server application, sending position data to the server application, receiving an XR pre-frame for a predicted pose of the XR device, determining whether a current pose matches the predicted pose, and rendering the XR pre-frame in response to the current pose being matching the predicted pose.

In one embodiment, an electronic device to execute a method of an XR application executed at a server includes a non-transitory computer-readable storage medium having stored therein a server application, and a processor coupled to the non-transitory computer-readable storage medium, the processor to execute the server application, the server application to receive BMI data encoding brain signaling metrics from an XR device, receive position data from the XR device, compute a pose prediction for a future time frame for the XR device using the BMI data and the position data, compute an XR pre-frame for the future time frame using the pose prediction, and send the XR pre-frame to the XR device.

In a further embodiment, a computing device to execute a method of an XR application in a software defined networking (SDN) network, the network device to execute a plurality of virtual machines, the plurality of virtual machines implementing network function virtualization (NFV), includes a non-transitory computer-readable storage medium having stored therein a server application, and a processor coupled to the non-transitory computer-readable storage medium, the processor to execute one of the plurality of virtual machines, the one of the plurality of virtual machines to execute the server application, the server application to receive BMI data encoding brain signaling metrics from an XR device, receive position data from the XR device, compute a pose prediction for a future time frame for the XR device using the BMI data and the position data, compute an XR pre-frame for the future time frame using the pose prediction, and send the XR pre-frame to the XR device.

In one embodiment, a control plane device to execute a method of an XR application in a SDN network includes a non-transitory computer-readable storage medium having stored therein a server application, and a processor coupled to the non-transitory computer-readable storage medium, the processor to execute the server application, the server application to receive BMI data encoding brain signaling metrics from an XR device, receive position data from the XR device, compute a pose prediction for a future time frame for the XR device using the BMI data and the position data, compute an XR pre-frame for the future time frame using the pose prediction, and send the XR pre-frame to the XR device.

### BRIEF DESCRIPTION OF THE DRAWINGS

The invention may best be understood by referring to the following description and accompanying drawings that are used to illustrate embodiments of the invention. In the drawings:

FIG. 1 is a diagram of one embodiment of a basic operation of an extended reality (XR) headset.

FIG. 2 is a diagram of one embodiment of the interaction between an XR device and a server application.

FIG. 3A is a diagram of one embodiment of the processes of the XR device and server application to update the XR device display.

FIG. 3B is a diagram of one embodiment of the processes of the XR device and server application to update the XR device display where prediction time is utilized.

FIG. 4 is a diagram of one embodiment of the interactions between an XR device and a server application.

FIG. 5 is a flowchart of one embodiment of a process of the operation of an XR headset.

FIG. 6 is a flowchart of one embodiment of a server application.

FIG. 7 is a diagram of one embodiment of the interaction of the components of the XR headset and the server application.

FIG. 8 is a timing diagram of the interaction between the XR headset and a server application.

FIG. 9A illustrates connectivity between network devices (NDs) within an exemplary network, as well as three exemplary implementations of the NDs, according to some embodiments of the invention.

FIG. 9B illustrates an exemplary way to implement a special-purpose network device according to some embodiments of the invention.

FIG. 9C illustrates various exemplary ways in which virtual network elements (VNEs) may be coupled according to some embodiments of the invention.

FIG. 9D illustrates a network with a single network element (NE) on each of the NDs, and within this straightforward approach contrasts a traditional distributed approach (commonly used by traditional routers) with a centralized approach for maintaining reachability and forwarding information (also called network control), according to some embodiments of the invention.

FIG. 9E illustrates the simple case of where each of the NDs implements a single NE, but a centralized control plane has abstracted multiple of the NEs in different NDs into (to represent) a single NE in one of the virtual network(s), according to some embodiments of the invention.

FIG. 9F illustrates a case where multiple VNEs are implemented on different NDs and are coupled to each other, and where a centralized control plane has abstracted these multiple VNEs such that they appear as a single VNE within one of the virtual networks, according to some embodiments of the invention.

FIG. 10 illustrates a general purpose control plane device with centralized control plane (CCP) software 1050), according to some embodiments of the invention.

### DETAILED DESCRIPTION

The following description describes methods and apparatus for improving the operation of extended reality (XR). In particular, the processes and system of the embodiments predict user and XR device movements based on monitoring neural activity and similar physical components of the user as inputs for a prediction system. The predictions system can then anticipate the movement of the user and the XR device enabling the creation of XR data for the predicted movement of the user and the XR device. Predicting the user and XR device movement enables higher quality XR information to be sent to the XR device in a timely manner and thereby improves the user experience.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

The embodiments relate to Motion-to-photon latency (MTP). Motion-to-photon latency is the time needed for a user to perform a motion to fully be reflected on the display. For example, when a user turns their head to the left, it might take 10 milliseconds (ms) before the content in the XR device (e.g., a head-mounted display (HMD)) to move to the right. The MTP latency, in this example, is 10 ms. Thus, the impact of MTP in XR is significant. Motion-to-photon latency in XR can be particularly crucial in augmented reality (AR) systems. For example, in AR systems, digital content is overlaid onto the real world via an HMD or similar device. Since there is no lag in the real world, latency is more obvious when the user perception registers all the objects coming from the real world relative to the digital world. A latency of up to 20 ms in VR systems and a latency of up to 5 ms in AR systems are recommended so the lag is not detected by the human eye.

Neural activity in the brain of the user prior to physical movement onset contains essential information for predictive assistance for those users using an XR device with a brain-machine-interface (BMI). BMI can include magneto-encephalography (MEG), electro-encephalography (EEG), and similar technologies. MEG and EEG are technologies that use magneto/electro-sensors as BMIs to measure specific signals from the body of a user. MEG is a less invasive BMI. EEG is more sensitive to radial current signals on the scalp.

These technologies can be applied to vision perception (to better address visual stimulus from advertisements), auditory and language processing (to reduce misinterpretation of language), remote control of vehicles, autonomous movement of people with handicaps, and similar cases. While the examples herein primarily relate to MEG, one skilled in the art would appreciate that EEG and similar technologies can also be utilized in place of MEG, in combination with MEG, or in various permutations.

When a user moves a muscle or a set of muscles there is a very complex and long process involved. The muscle movement process starts with the conscious decision to move part of our body, then our brain translates this intention in a set of commands that are sent to a set of muscles, then those commands are sent to the cerebellum that sends the proper stimulus to each muscle. At the end of this process, those muscles move. All of the steps use neurons that use spikes of electricity to work at varying frequency depending on the kind of signal to send. This electricity generates electromagnetic signals all around the brain that can be captured by MEG sensors. MEG sensors use inductances, little antennas, to receive the brain signals. Any number of sensors can be employed to capture these signals depending on the level of detail and accuracy. The number of required sensors depends on the complexity of the operation and the computation capacity. For example, to monitor the healthiness of meditation, just three sensors could be used.

These sensors are responsible to measure the magnetic field in their local area and transmit the measure to a computer that is responsible to elaborate them. Each signal is measured several times per second and the resulting data is a function in time. Each thinking or intention generates a specific pattern. A computer program can analyze these signals and is able to recognize specific patterns and is thereby able to recognize specific thinking. Both active and passive versions of the MEG technologies can be utilized.

For new technologies like XR, the fifth generation (5G) technology standard developed by the 3rd Generation Partnership Project (3GPP) is a key technology to provide low latencies needed for XR. However, even with 5G there are still physical limits that can impact these XR technologies. For XR technologies, the 5G radio network can have a key role in minimizing the latency between the XR device and an electronic device that is providing XR information to the XR device or providing computational support. For example, the electronic device can be a computation unit that performs graphics processing (e.g., the electronic device can include a graphics processing unit (GPU) that generates video or imaging for the XR device to render).

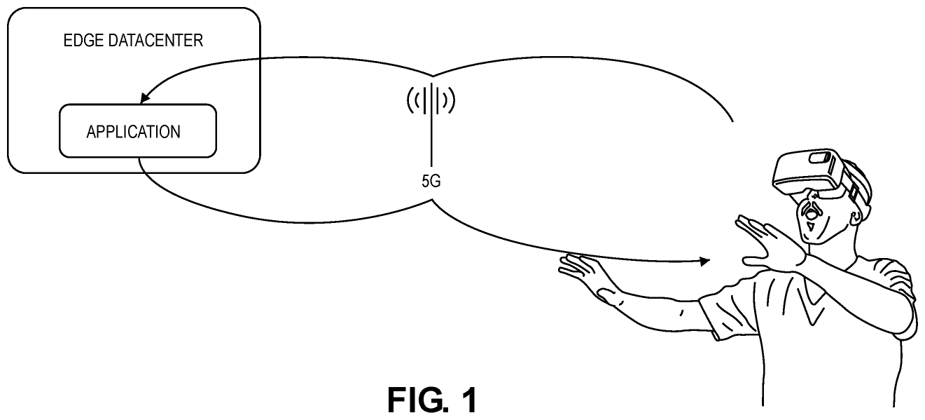

FIG. 1 is a diagram of one embodiment of an XR device interacting with an application in a telecommunication network. In this example, the telecommunication network is a 5G network. However, other similar low latency technologies can be utilized. In this example, a user uses an XR device for gaming. This XR device can be light because it does not require a large processing capacity. Most of the processing capacity in this example is delegated to an edge datacenter via a 5G network.

In this example, an image shown to the XR game player by the XR device is based on his head movement and position. The XR device collects or determines this head movement and position information, which is sent in real-time to the application at the edge datacenter (via low latency communication, on 5G networks) and the application generates the image to be shown to the user at the XR device. As soon as the image is ready (after few milliseconds), it is sent back to the user's XR device.

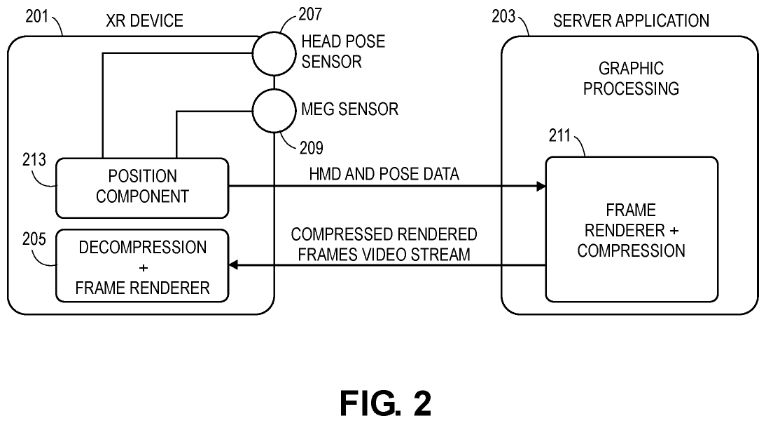

FIG. 2 is a diagram of one embodiment of the interactions between an XR device and a server application. In this example, the XR device is an XR headset 201 for gaming. The XR headset 201 can be light because the XR headset 201 does not require a large processing capacity. Most of the processing capacity is delegated to a server application 203 at an edge datacenter that is accessible via 5G networks or similar telecommunication infrastructure.

The image shown by the XR headset 201 to the user is based on head movement and position collected by head position sensors 207 and MEG sensors 209. The head movement and position information of the user and XR headset 201 is collected by a position component 213 and sent in real-time to the server application 203 via low latency communication, e.g., 5G networks. The server application 203 generates the image to be shown to the user and can have enhanced graphics processing capabilities. In some embodiments, the image can be compressed. In these embodiments, a frame renderer and compression unit 211 can generate the image and, after a few milliseconds, send the image as a compressed rendered frame back to the XR headset 201 as part of a video stream. This compressed rendered frame video stream can be received by the XR headset 201 and processed by a decompression and frame renderer unit 205 to recover the image generated by the server application 203.

This “closed loop” of positional data collection and transmission, frame rendering, and video streaming takes at least a few milliseconds under the best conditions. The best perception and experience for the user player, is the case where the lowest latency and highest bandwidth video stream is produced. One of the technical problems in this system is that the required (i.e., minimum) latency is really close to the physical limit of signal propagation for the closed loop.

The technical problem can be illustrated with an example where a person talks to a friend via a telephone. For sake of the example, the telephone does not spend any time to transform video to signals and also latency is just on the transmission (e.g., through optical fibers). This is the best scenario, but in real-world conditions it is not attainable. In this hypothetical case, the voice signal of the user runs for 2000 kilometers (km) in 10 ms to reach the destination. If there are routers/repeaters in the line, there is an additional processing time that should be considered. In this example, the routers/repeaters spend 5 ms to process the signal and re-generate it. This means that, in 10 milliseconds, the image sent by the user spends 5 ms to be routed and 5 ms to run through networks. The maximum distance the signal can run in 5 ms is 1000 Km.

Those 1000 Km will decrease if other factors are considered such as the time the telephone of the user spends to process the image and to send the signal, the reduction in signal speed in case of metal cables (instead of optical fibers), and similar factors. So, this simplified example computation demonstrates that the maximum distance between a user and the destination (an edge application, usually) should not be more than some hundreds of kilometers to minimize latency.

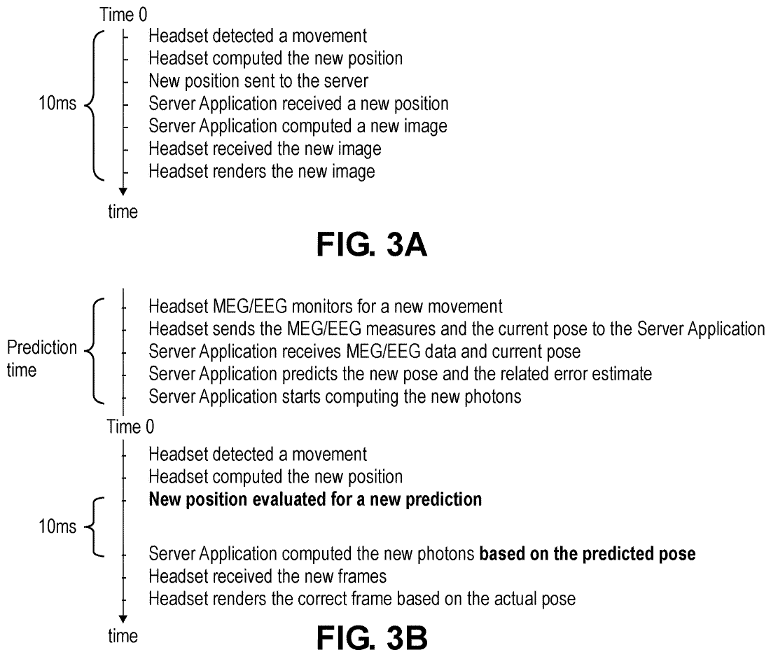

FIG. 3A is a diagram of the actions to be performed within the 10 ms time frame. The diagram summarizes the major activities the system should perform in this limited time include detecting and collecting the XR device's (e.g., headset) movement positional information, computing an updated position, sending positional information to the server application, receiving the positional information at the server application, computing an image at the server application, sending the image to the XR device, and rendering the image at the XR device. These steps and any intermediary steps are to be performed within 10 ms from the start of positional information collection.

The time limits force the server application to be hosted proximate to the user devices in a local server or in a local cloud, where “local” means as close to the XR device as possible, on the order of 10s of kms rather than 100s of kms. The cost of such infrastructure to support such a proximate position for the necessary processing power e.g., at an edge datacenter is very high. Even if telecommunication providers invest local edge datacenters, the cost of hosting these server applications will still be very high.

The embodiments provide a system to relax or expand these physical limitations while the system can also extend the current XR device and server application capabilities. In reference to the illustrated timeline, the embodiments extend the available time beyond (i.e., before) the ‘time 0,’ using Magneto/Electro-encephalography (MEG and EEG), machine learning, and related or similar technologies. The embodiment provides a method and apparatus to relax the physical limit of XR applications to be deployed closer to the end-user, to maximize the end-user experience.

The embodiments are based on the prediction of XR device movements using MEG, EEG or similar technology. The predicted position can be used to process future streamed video or image frames. In some embodiments, multiple predictions can be made such that a few frames can be pre-processed for a given time slot to solve possible prediction errors. In the example embodiments described herein, streamed video and image ‘frames’ are transmitted from the application server to the XR device. As used herein the term ‘frame’ is used to represent any one or more of streamed video frames and individual image frames, or similar divisions or formats of visual data.

The embodiments provide advantages over the current art. The advantages include being able to relax proximity requirements for server application location, increased frame quality, lower cost of frame rendering, increased frame rate, and similar improvements that can lead to improved user experiences including more immersive experiences. The embodiments are able to relax the proximity requirement such that the maximum latency required by XR applications supports a heavy distribution of applications to edge datacenters, but with the additional latency to enable the system to centralize those applications to fewer locations. The consequent advantage is the lower cost and more specialized hardware support.

The embodiments increase the frame quality with a lower cost because the pose prediction allows XR server applications to spend more time in processing the frames. The greater the available processing time, the greater the expected frame quality can be. The embodiments can increase the high quality frame rate if the prediction has a high confidence. The system can deliver and use the predicted frames before a target 20 ms. This means the frame rate can be higher. The embodiments can support improved experiences in the XR devices that opens the market to new opportunities for more immersive experiences. The proposed embodiments open the XR applications to be more integrated with the end-user. The end user intentions are monitored and can be used to interact with the application without any need of additional tools/interfaces.

XR applications require low latency between the XR device and the processing device to process the frames to be displayed. This technological constraint implies such XR applications should be closer to the end-user. XR applications are typically resource intensive in both memory usage and compute usage. They require high processing capacity, usually Graphic Processing Units (GPUs, high capacity central processing units (CPUs) with high speed random access memory (RAM)). Due to the resource intensive nature of these XR applications, increasing the proximity means increasing the cost of the overall solution since high quality processing and memory resources will need to be nearly ubiquitous geographically. In a large scale, this approach incurs high hardware costs, and it affects the related business case for supporting XR. For this reason, there is a significant benefit to centralize XR applications. The synergy between the higher quality and the lower cost is a significant advantage of the embodiments.

XR applications are preferably deployed on edge datacenters, where the operational cost is high, but because of the physical limits of latency, it is not possible to move them further toward a centralized datacenter model. The key positional information utilized to compute the correct video/image frame and sound for the XR device is the head position, or “pose.” A ‘pose’ is defined as any one or more of a set of 6 measurements that can include a set of 3 angles (omega, phi and kappa) and a set of 3 spatial coordinates (x, y and z coordinates in space). Any movement of the XR device or change in these positional measurements can be considered as a new “pose.” A ‘set,’ as used herein refers to any whole number of items including one item.

As shown in relation to FIG. 2, the XR system rushes as soon as it detects a movement and has just 10 ms to complete the process. The XR device measures new positional information via sensors and starts the computation of a new pose, locally or remotely, depending on the application location. With respect to the headset processing speed and the communication speed, the human movement is hundreds of times slower. As an example, if a person moves an arm, before stopping his movement, his brain must spend time to process the need of stopping, send the new signal to muscles and activate them. So, the embodiments can sense this processing of the intended body movement and while the user attempts to implement the action the XR system can predict the XR device movement. By predicting the XR device movement, all the other steps can be performed with more time, i.e., more than the 10 ms limitation.

FIG. 3B is a diagram of the process between the XR device, and the server application based on the embodiments. The embodiments aim to predict the head pose milliseconds into the future, which provides the extra time to process this data beyond the prior 10 ms timeline. The updated timeline is based on a prediction that makes use of MEG/EEG or similar technology that makes it possible to predict body movements with a good approximation by monitoring the human brain activity.

Thus, the timeline in FIG. 3B begins with a continuous monitoring and collecting of MEG/EEG or similar technology for signals that being a new user movement. The XR device sends the MEG/EEG or similar technology measurements and the current pose to the server application. The server application receives the MEG/EEG or similar technology measurements and current pose information. The server application then predicts a new pose (P(t+N)) along with an error estimate. The server application can also start computing new photons.

At time 0, the XR device detects a change in movement, computes a new position, and the new position is evaluated for a new prediction. The server application computes new photons and frames based on the predicted pose and sends the new photons and frames to the XR device. The XR device renders predicted frames selected based on the current actual pose that has been determined.

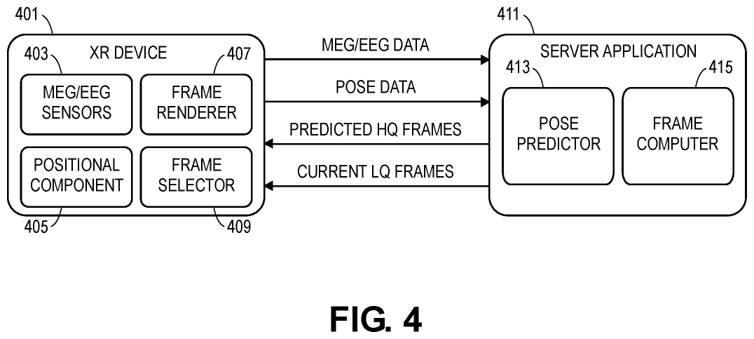

FIG. 4 is a diagram of one embodiment of the interactions between the components of the XR device and the server application. The embodiments are described in relation to an architecture with two main systems: the XR device 401 and a supporting server application 411. In other embodiments, other divisions of functionality can be utilized consistent with the principles and operations of the embodiments. The XR device 401 can be any type of electronic device that is capable of directly or indirectly communicating with the server application 411 to provide XR related functionality (e.g., XR gaming).

The XR device 401 can include a set of MEG/EEG sensors 403, a positional component 405, frame renderer 407, and a frame selector 409. The MEG/EEG sensors 403 or similar technology sense user movements through neurological or electrical activity of the body (e.g., brain activity). The positional component 405 computes a current position of the XR device 401 based on the MEG/EEG sensors 403 and other sensor information. The frame renderer 407 renders frames received from the server application or locally generated to be displayed via a display device of the XR device 401 or connected to the XR device 401. The frame selector 409 determines which of the frames received from the server application 411 are to be used based on the current pose of the XR device 401 as determined by the positional component 405.

The data exchanged between the XR device 401 and the server application 411 can include MEG/EEG data or similar information that is sent to the server application. Positional information (i.e., pose data) is sent to the server application by the positional component. The server application 411 sends predicted high quality (HQ) frames and current lower quality (LQ) frames in cases where predictions were inaccurate.

The server application 411 can run on any edge datacenter, server, cloud computing datacenter, or similar computing environment. The server application 411 can be specific to an XR application at the XR device 401, the XR device 401, or more general for a group of XR devices or applications. The server application 411 can be an instance that serves a single XR device 401 or that services any number of connected XR devices. The server application 411 can include a pose predictor 413, a frame computer 415, and similar components. The pose predictor 413 can utilize the received positional information and MEG/EEG or similar data to predict a pose of the XR device 401 at any number of frames into the future, generally between 10 and 30 ms into the future. The pose predictor 413 can be a machine learning model or similar implementation that is trained on MEG/EEG data to predict poses. The frame computer 415 can be a graphics processing function that generates frames for a predicted pose using XR information of the server application to generate video/images such as video game display screens and video, audio, screen overlays, and similar images and sounds. These frames are packaged in any format associated with particular time or sequences and returned to the XR device 401.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

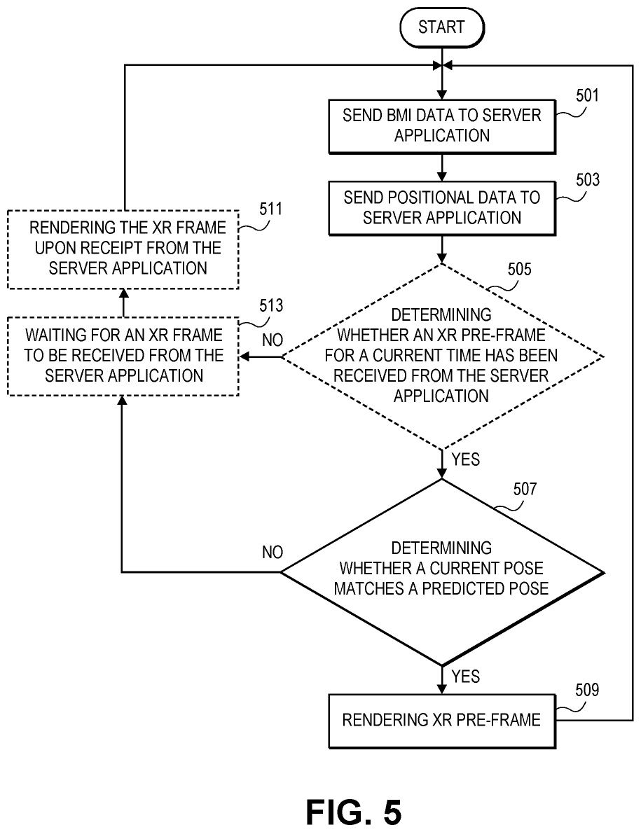

FIG. 5 is a flowchart of one embodiment of the process of the XR device. The embodiments operate to predict XR device user poses after a monitoring time ‘T’ such that the current position at time t is P(t). The current data from the MEG/EEG or similar system at time t is E(t). The estimated future pose at time t+N is P(t+N) where N is a number of frames into the future. The related predicted frame is Frame(t+N).

From the XR device the process is initiated at the startup of the XR device. The headset continuously sends MEG/EEG data or similar BMI data to the server application as this data is collected or as it changes (Block 501). This data is collected at time t and as mentioned can be expressed as E(t). Similarly, the XR device continuously collects sensor information for position of the XR device using any type or variety of position sensing sensors such as gyroscopes, global positioning systems (GPS), and similar components (Block 503). This current position information is also for time t and can be expressed as P(t). This information can be processed at the XR device to determine or infer further position information that is provided to the service application.

When the current position is determined, a check can be made to determine whether XR pre-frames (i.e., frames based on predicted positions) for the determined position have already been received from the XR service application (Block 505). If XR pre-frames have not been received, then the XR device awaits receipt of the XR frames for the reported position of the XR device (Block 513). The frame to be received can be expressed as Frame(t). Once the frame for the current position at time t is received, then it can be rendered by the XR device for display (Block 511). The frame (i.e., Frame(t)) may be of lower quality (e.g., in terms of resolution or rendering quality such as shading, lighting, anti-aliasing, and similar aspects of image quality), than a pre-frame.

If an XR pre-frame or a set of XR pre-frames for the current time has been received, a check is made whether any of the XR pre-frames have a predicted position that matches the current position (Block 507). A match between a current pose and a predicted pose can be determined by comparison of any one or more of a set of measurements in each pose set (i.e., 3 angles (omega, phi, and kappa), and three spatial coordinates (x, y, z coordinates in space). A match can be found when any number of these measurements are equal to one another or within a defined tolerance (e.g., within 10% of one another). The tolerance or degree of accuracy can be any pre-defined range or threshold. The tolerance or degree of accuracy for each measurement can be individually defined such that a lower tolerance or higher degree of accuracy can be required for some pose measurements (e.g., the set of angles) than other measurements (e.g., the spatial coordinates). If none of the received set of XR pre-frames have a matching position, then the process waits for the current frame (i.e., Frame(t)) to be received from the server application (Block 513). If an XR pre-frame with a matching position is found, then the XR pre-frame is selected to be rendered (Block 509) and displayed via a display attached to the XR device. XR pre-frames have a higher quality (e.g., higher resolution, improved shading, lighting, anti-aliasing, and similar aspects of image quality). The process of the XR device leverages a server application that provides the proper XR pre-frames or the current lower quality frames where a mis-prediction occurs.

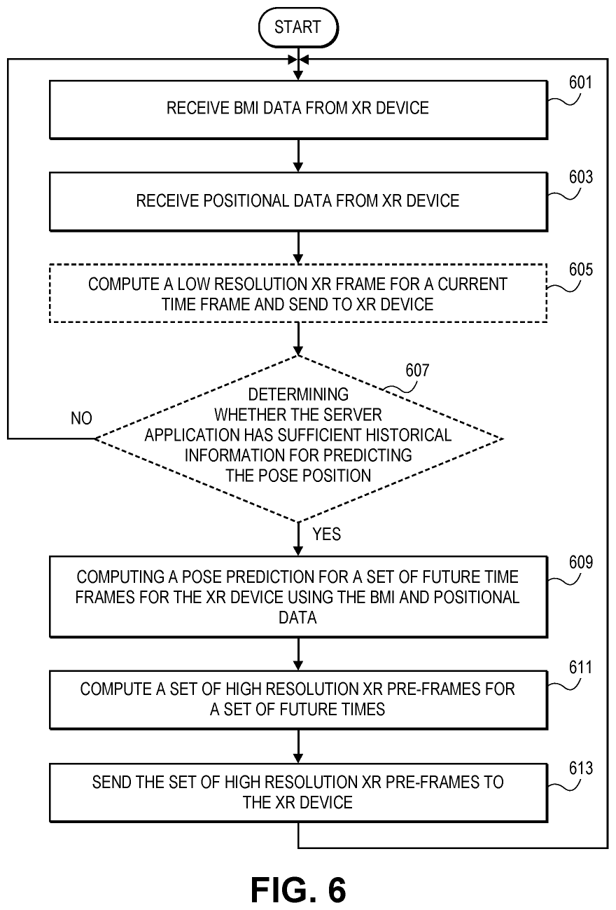

FIG. 6 is a flowchart of one embodiment of the operation of the server application. The server application can be initiated or instantiated in response to an initial connection request of the XR device or under similar circumstances. There can be an initial time T that is required to start predicting positions. During this time, the XR application does not make any prediction and the process generates low-quality frames (Block 605) because the processing time is limited. After the time T, the continuously received BMI data, which can be expressed as E(t) (Block 601) and position information, which can be expressed as P(t) (Block 603) are sufficient to enable the XR system to make predictions. Once the amount of historical BMI data is determined to be sufficient to make predictions (Block 607), then the XR server application starts to compute pose predictions for a set of future time frames relative to the current time frame (Block 609). The set of future time frames have a higher quality relative to the low quality frames in terms of resolution, shading, textures, lighting, and similar aspects of image or video quality. The set of future or predicted frames is then computed as XR pre-frames that are then sent to the XR device (Blocks 611 and 613).

In some embodiments, as BMI data is initially received the system computes the low-quality frame in case the prediction is wrong, or for the first several iterations or an initial time frame. In this case, the predictions are still made and XR pre-frames generated. In other embodiments, the server application checks if there are sufficient iterations to make a pose prediction. If a prediction is not feasible, then the flow will wait for additional data. If prediction is feasible, then the system makes a pose prediction for a certain future period (dependent on the prediction error estimate), computes the related frames at high-quality, and sends the result to the XR device. As soon as the resulting frames are sent, the server application can restart the flow and wait for new data. In further embodiments, this is a continuous process both on the receiving of updated data and the generation of XR pre-frames with the system predicting poses a set number of frames into the future given current historical data received from the XR device.

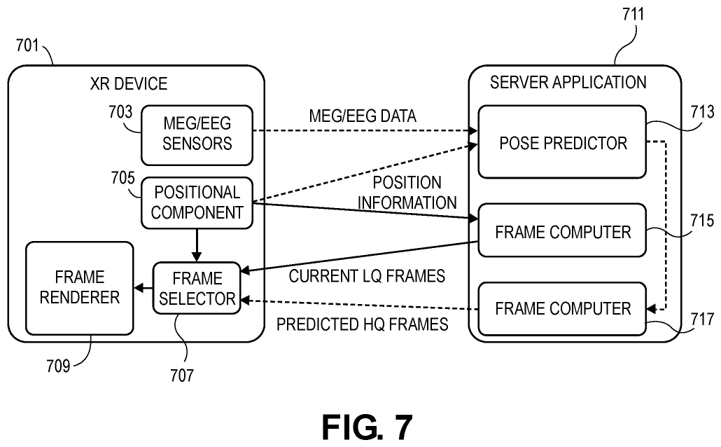

FIG. 7 is a diagram of one embodiment of the interactions between the XR device and the server application. In this diagram, the solid flow is the basic flow where the positional component 705 receives data from sensors including positional sensors and the MEG/EEG sensors 703. The positional component collaborates with the server application 711 at the edge datacenter or similar location to create a closed loop with a latency less than 20 ms. The dotted line flow is the expanded parallel flow where the MEG/EEG sensors 703 together with the pose sensors and positional component 705 give enough information to the pose predictor 713 to perform prediction. The resulting predicted pose is then used to compute the predicted frames, which are sent back to the XR device 701.

The server application 711 includes the functions of the pose predictor 713, and frame computers 715, 717. The frame computers 715, 717 generate low and high quality frames based on received positional data from the XR device 701 and pose predictions of the pose predictor 713, respectively. The two flows provide predicted high quality and current low quality frames to a frame selector 707 that, depending on the accuracy of the predicted pose with respect to the actual current pose, decides whether to use the predicted frames or the low quality one. The frame renderer 709 renders the selected frames for the XR device 701 display.

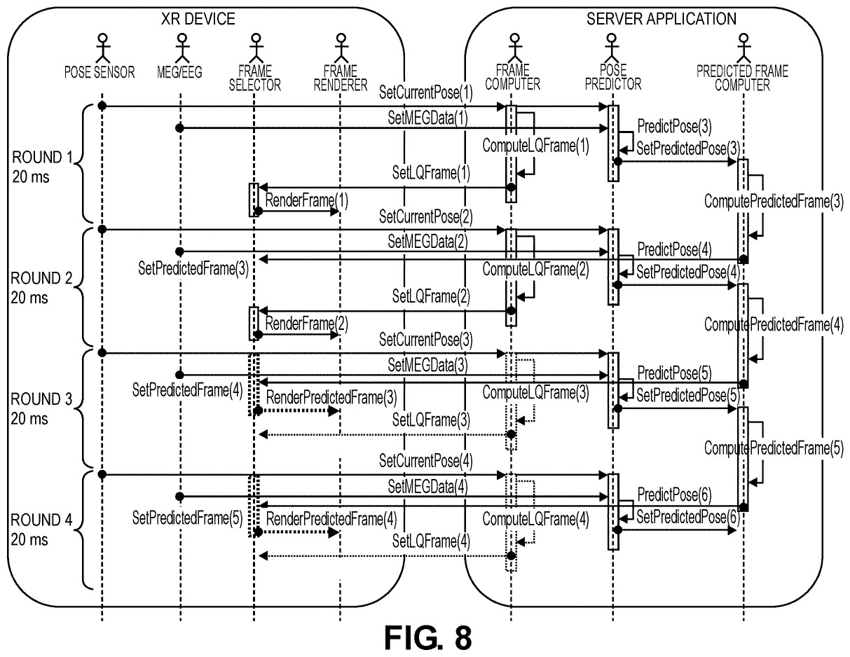

FIG. 8 is a timing diagram that illustrates the timing of the interaction between the XR device (e.g., XR headset) and the server application. From a temporal perspective, the frames will be created by the server application and sent to the XR device at different times to be able to create high quality and/or low quality frames. The timing diagram shows the various communications and computations in a temporal perspective where there are four rounds of frame generation each taking place over 20 ms. While these rounds are shown as a sequence with one round starting and ending before the next round, the rounds may in fact overlap with one round starting before the next but ending during the subsequent round.

The timing diagram illustrates that the embodiments enable an XR device to render predicted high quality frames in a few milliseconds, much less than the conventional solution. In the timing diagram there are 4 iterations of 20 ms each. The 20 ms duration is provided as an example and can be less than 20 ms. Each iteration starts with pose measurements, which are sent by the XR device to the pose predictor by a function call (SetCurrentPose).

In the timing sequence diagram, there are several components of the XR device and the server application. In this example embodiment, the involved components are the same functional components described herein in relation to FIG. 7. The XR device includes the functions/components of the positional component, MEG/EEG sensors, frames selector, and frames renderer. The server application contains the following functions and components: frame computer, pose predictor, and predicted frame computer.

In the timing diagram, the number in each communication (e.g., using the function SetCurrentPose(1)) refers to the frame number that it contributes to compute; the example SetCurrentPose(1) aims to process the frame 1. Moreover, it helps to identify each communication in the timing diagram. In “Round 1,” the XR device starts sending pose measurements to the frame computer and the pose predictor within the server application (e.g., using a function SetCurrentPose(1) to send the pose measurements). The frame selector also receives this information internal to the XR device.

As soon as the frame computer and pose predictor receive the pose measure, the frame computer immediately computes the related frame as quickly as possible (e.g., using the function ComputeLQFrame(1), while the pose predictor waits for the MEG/EEG data from the XR device. When the MEG/EEG sensors or related function in the XR device sends new measures (e.g., using the function SetMEGData(1)), the pose predictor starts to predict a future pose (e.g., using the function PredictPose(3)). In this example, the pose predictor is configured to predict the pose of 2 Rounds in the future, for this reason the number 3 is used to identify Round 3 frames. However, any number of frames into the future could be generated including multiple different frames at different ‘rounds.’ The pose prediction completes, and returns the predicted pose (e.g., using the function SetPredictedPose(3)), which triggers the predicted frame computer to compute the predicted frame (e.g., using the function ComputePredictedFrame(3)).

While the ComputePredictedFrame(3) function is ongoing, the low quality frame is returned back to the XR device (e.g., using the function SetLQFrame(1)) and rendered (e.g., using the function RenderFrame(1)). The frame selector at this point does not have anything else to select than the low-quality frame 1, because the server application predictions have not produced any predicted frames yet.

At this point, the XR device measures the new pose and the new MEG/EEG data. The result is sent to the server application in the same manner as in Round 1 (e.g., using the functions SetCurrentPose(2) and SetMEGData(2)). The sequence is the same as Round 1, but this time the function ComputePredictedFrame(3) completes and ComputePredictedFrame(4) starts. The predicted frame 3 is sent to the XR device (e.g., using the function SetPredictedFrame(3)). This means the frame selector has now a predicted frame 3 that can be selected if the actual pose 3 correlates with the predicted pose for predicted frame 3.

While the function ComputePredictedFrame(4) is ongoing, the third round starts. The new pose 3 is measured and sent to the server application (e.g., using the function SetCurrentPose(3)), but this time frame selector compares the actual pose 3 with the predicted pose 3. The timing diagram shows the situation where the predicted pose matches the actual pose, so the frame selector can immediately send RenderPredictedFrame(3) to the frame renderer to render the high-quality frame 3 (previously predicted) and not wait for the low quality frame.

It is also visible in Round 3 that “ComputeLQFrame(3)” is greyed out. This is because the frame computer is able to check that the actual pose 3 matches the predicted pose 3, and because they match, it is not useful to compute the related low-quality frame, and it can be assumed that the frame selector in the XR device has selected the predicted frame 3. In the same way, in Round 4 the predicted frame 4 matches the measured pose 4, as in Round 3, the rendered frame is the predicted one and the ComputeLQFrame(4) is not executed.

The embodiments thus leverage the high bandwidth and low latency of 5G networks, but in some cases, there can be some side effects. The required download bandwidth can increase because the system needs to communicate the predicted high-quality frames in addition to the previous data. By using 5G or similar networks, this extra download bandwidth should not be an issue. The required upload bandwidth can slightly increase to communicate MEG/EEG data to the server application. This data can be sent because of the need to offload from the XR device as much of the processing required to predict poses as possible. The amount of this data is extremely low, compared to frame data.

With the embodiments it is also possible to increase the frame rate. For example, Rounds 3 and 4 do not need to wait for the functions SetLQFrame(3) and SetLQFrame(4) (see dotted line sections), but the XR device can already send the new pose and EEG/MEG data to the server application and start a new prediction/computation. If the frame rate increases, the pose predictor has to predict poses at a shorter interval. If the prediction interval decreases, the pose prediction increases its reliability. This is a side effect of the fact that in nature everything moves smoothly, nothing moves with infinite acceleration. Moreover, if the system can predict more poses than a single one with a proper reliability, the time between one frame and the other can be shorter than the prediction time.

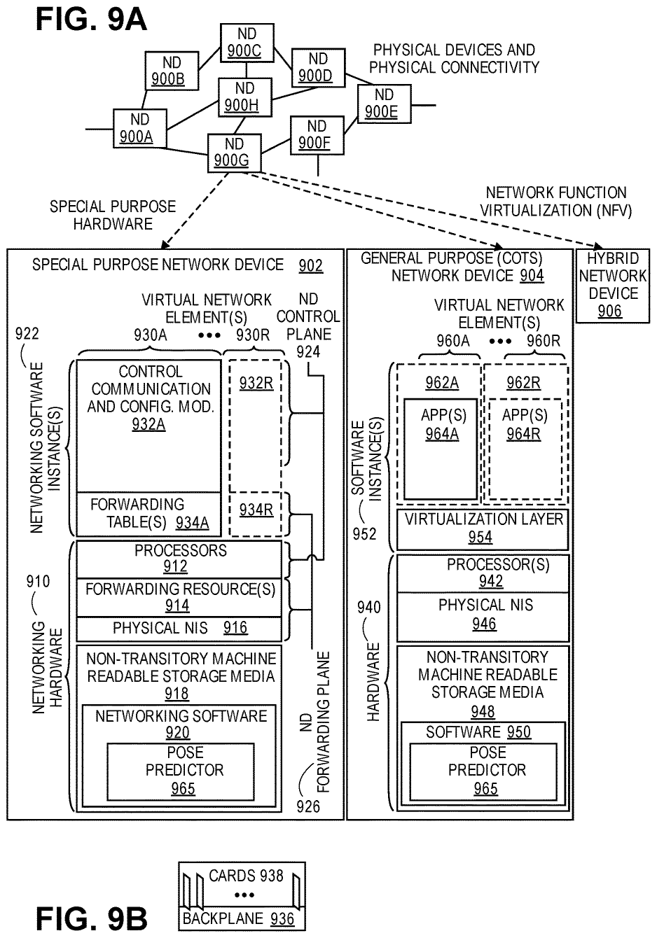

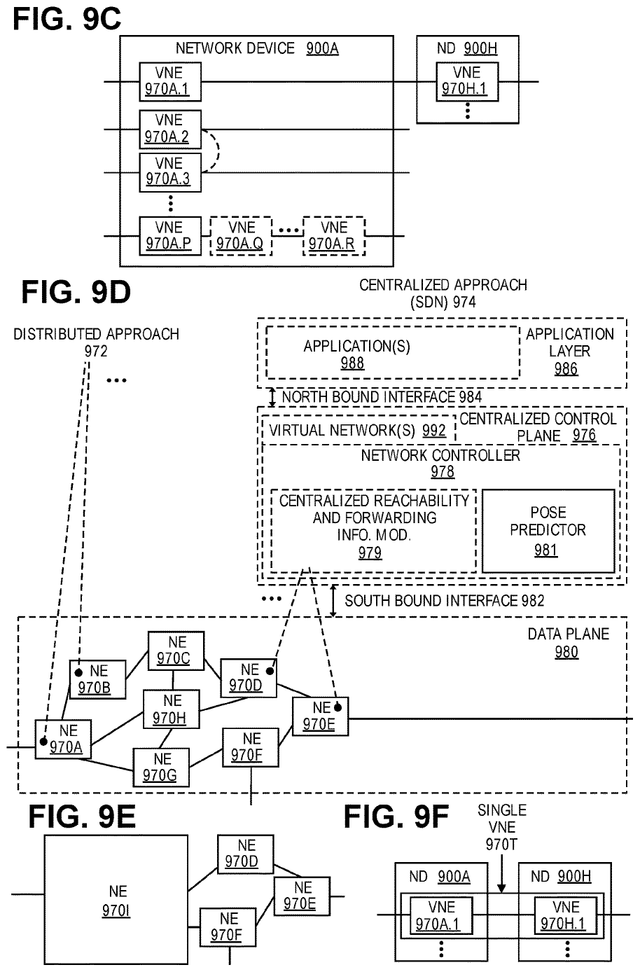

FIG. 9A illustrates connectivity between network devices (NDs) within an exemplary network, as well as three exemplary implementations of the NDs, according to some embodiments of the invention. FIG. 9A shows NDs 900A-H, and their connectivity by way of lines between 900A-900B, 900B-900C, 900C-900D, 900D-900E, 900E-900F, 900F-900G, and 900A-900G, as well as between 900H and each of 900A, 900C, 900D, and 900G. These NDs are physical devices, and the connectivity between these NDs can be wireless or wired (often referred to as a link). An additional line extending from NDs 900A, 900E, and 900F illustrates that these NDs act as ingress and egress points for the network (and thus, these NDs are sometimes referred to as edge NDs; while the other NDs may be called core NDs).

Two of the exemplary ND implementations in FIG. 9A are: 1) a special-purpose network device 902 that uses custom application—specific integrated—circuits (ASICs) and a special-purpose operating system (OS); and 2) a general purpose network device 904 that uses common off-the-shelf (COTS) processors and a standard OS.

The special-purpose network device 902 includes networking hardware 910 comprising a set of one or more processor(s) 912, forwarding resource(s) 914 (which typically include one or more ASICs and/or network processors), and physical network interfaces (NIs) 916 (through which network connections are made, such as those shown by the connectivity between NDs 900A-H), as well as non-transitory machine readable storage media 918 having stored therein networking software 920. During operation, the networking software 920 may be executed by the networking hardware 910 to instantiate a set of one or more networking software instance(s) 922. Each of the networking software instance(s) 922, and that part of the networking hardware 910 that executes that network software instance (be it hardware dedicated to that networking software instance and/or time slices of hardware temporally shared by that networking software instance with others of the networking software instance(s) 922), form a separate virtual network element 930A-R. Each of the virtual network element(s) (VNEs) 930A-R includes a control communication and configuration module 932A-R (sometimes referred to as a local control module or control communication module) and forwarding table(s) 934A-R, such that a given virtual network element (e.g., 930A) includes the control communication and configuration module (e.g., 932A), a set of one or more forwarding table(s) (e.g., 934A), and that portion of the networking hardware 910 that executes the virtual network element (e.g., 930A).

The functions of the pose predictor 965 and similar components can be stored as code in the non-transitory machine readable storage media 918 as part of the networking software 920. The pose predictor 965 and similar components can be executed by the processors 912 to perform the functions of the server application or XR device as described herein.

The special-purpose network device 902 is often physically and/or logically considered to include: 1) a ND control plane 924 (sometimes referred to as a control plane) comprising the processor(s) 912 that execute the control communication and configuration module(s) 932A-R; and 2) a ND forwarding plane 926 (sometimes referred to as a forwarding plane, a data plane, or a media plane) comprising the forwarding resource(s) 914 that utilize the forwarding table(s) 934A-R and the physical NIs 916. By way of example, where the ND is a router (or is implementing routing functionality), the ND control plane 924 (the processor(s) 912 executing the control communication and configuration module(s) 932A-R) is typically responsible for participating in controlling how data (e.g., packets) is to be routed (e.g., the next hop for the data and the outgoing physical NI for that data) and storing that routing information in the forwarding table(s) 934A-R, and the ND forwarding plane 926 is responsible for receiving that data on the physical NIs 916 and forwarding that data out the appropriate ones of the physical NIs 916 based on the forwarding table(s) 934A-R.

FIG. 9B illustrates an exemplary way to implement the special-purpose network device 902 according to some embodiments of the invention. FIG. 9B shows a special-purpose network device including cards 938 (typically hot pluggable). While in some embodiments the cards 938 are of two types (one or more that operate as the ND forwarding plane 926 (sometimes called line cards), and one or more that operate to implement the ND control plane 924 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 936 (e.g., a first full mesh coupling the line cards and a second full mesh coupling all of the cards).

Returning to FIG. 9A, the general purpose network device 904 includes hardware 940 comprising a set of one or more processor(s) 942 (which are often COTS processors) and physical NIs 946, as well as non-transitory machine readable storage media 948 having stored therein software 950. During operation, the processor(s) 942 execute the software 950 to instantiate one or more sets of one or more applications 964A-R. While one embodiment does not implement virtualization, alternative embodiments may use different forms of virtualization. For example, in one such alternative embodiment the virtualization layer 954 represents the kernel of an operating system (or a shim executing on a base operating system) that allows for the creation of multiple instances 962A-R called software containers that may each be used to execute one (or more) of the sets of applications 964A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 954 represents a hypervisor (sometimes referred to as a virtual machine monitor (VMM)) or a hypervisor executing on top of a host operating system, and each of the sets of applications 964A-R is run on top of a guest operating system within an instance 962A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 940, directly on a hypervisor (in which case the unikernel is sometimes described as running within a LibOS virtual machine), or in a software container, embodiments can be implemented fully with unikernels running directly on a hypervisor represented by virtualization layer 954, unikernels running within software containers represented by instances 962A-R, or as a combination of unikernels and the above-described techniques (e.g., unikernels and virtual machines both run directly on a hypervisor, unikernels and sets of applications that are run in different software containers).

The functions of the pose predictor 965 and similar components can be stored as code in the non-transitory machine readable storage media 948 as part of the software 950. The pose predictor 965 and similar components can be executed by the processors 942 to perform the functions of the server application or XR device as described herein.

The instantiation of the one or more sets of one or more applications 964A-R, as well as virtualization if implemented, are collectively referred to as software instance(s) 952. Each set of applications 964A-R, corresponding virtualization construct (e.g., instance 962A-R) if implemented, and that part of the hardware 940 that executes them (be it hardware dedicated to that execution and/or time slices of hardware temporally shared), forms a separate virtual network element(s) 960A-R.

The virtual network element(s) 960A-R perform similar functionality to the virtual network element(s) 930A-R—e.g., similar to the control communication and configuration module(s) 932A and forwarding table(s) 934A (this virtualization of the hardware 940 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 962A-R corresponding to one VNE 960A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 962A-R to VNEs also apply to embodiments where such a finer level of granularity and/or unikernels are used.

In certain embodiments, the virtualization layer 954 includes a virtual switch that provides similar forwarding services as a physical Ethernet switch. Specifically, this virtual switch forwards traffic between instances 962A-R and the physical NI(s) 946, as well as optionally between the instances 962A-R; in addition, this virtual switch may enforce network isolation between the VNEs 960A-R that by policy are not permitted to communicate with each other (e.g., by honoring virtual local area networks (VLANs)).

The third exemplary ND implementation in FIG. 9A is a hybrid network device 906, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 902) could provide for para-virtualization to the networking hardware present in the hybrid network device 906.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also, in all of the above exemplary implementations, each of the VNEs (e.g., VNE(s) 930A-R, VNEs 960A-R, and those in the hybrid network device 906) receives data on the physical NIs (e.g., 916, 946) and forwards that data out the appropriate ones of the physical NIs (e.g., 916, 946). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

FIG. 9C illustrates various exemplary ways in which VNEs may be coupled according to some embodiments of the invention. FIG. 9C shows VNEs 970A.1-970A.P (and optionally VNEs 970A.Q-970A.R) implemented in ND 900A and VNE 970H.1 in ND 900H. In FIG. 9C, VNEs 970A.1-P are separate from each other in the sense that they can receive packets from outside ND 900A and forward packets outside of ND 900A; VNE 970A.1 is coupled with VNE 970H.1, and thus they communicate packets between their respective NDs; VNE 970A.2-970A.3 may optionally forward packets between themselves without forwarding them outside of the ND 900A; and VNE 970A.P may optionally be the first in a chain of VNEs that includes VNE 970A.Q followed by VNE 970A.R (this is sometimes referred to as dynamic service chaining, where each of the VNEs in the series of VNEs provides a different service—e.g., one or more layer 4-7 network services). While FIG. 9C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 9A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 9A may also host one or more such servers (e.g., in the case of the general purpose network device 904, one or more of the software instances 962A-R may operate as servers; the same would be true for the hybrid network device 906; in the case of the special-purpose network device 902, one or more such servers could also be run on a virtualization layer executed by the processor(s) 912); in which case the servers are said to be co-located with the VNEs of that ND.

A virtual network is a logical abstraction of a physical network (such as that in FIG. 9A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

FIG. 9D illustrates a network with a single network element on each of the NDs of FIG. 9A, and within this straightforward approach contrasts a traditional distributed approach (commonly used by traditional routers) with a centralized approach for maintaining reachability and forwarding information (also called network control), according to some embodiments of the invention. Specifically, FIG. 9D illustrates network elements (NEs) 970A-H with the same connectivity as the NDs 900A-H of FIG. 9A.

FIG. 9D illustrates that the distributed approach 972 distributes responsibility for generating the reachability and forwarding information across the NEs 970A-H; in other words, the process of neighbor discovery and topology discovery is distributed.

For example, where the special-purpose network device 902 is used, the control communication and configuration module(s) 932A-R of the ND control plane 924 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP), Label Distribution Protocol (LDP), Resource Reservation Protocol (RSVP) (including RSVP-Traffic Engineering (TE): Extensions to RSVP for LSP Tunnels and Generalized Multi-Protocol Label Switching (GMPLS) Signaling RSVP-TE)) that communicate with other NEs to exchange routes, and then selects those routes based on one or more routing metrics. Thus, the NEs 970A-H (e.g., the processor(s) 912 executing the control communication and configuration module(s) 932A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 924. The ND control plane 924 programs the ND forwarding plane 926 with information (e.g., adjacency and route information) based on the routing structure(s). For example, the ND control plane 924 programs the adjacency and route information into one or more forwarding table(s) 934A-R (e.g., Forwarding Information Base (FIB), Label Forwarding Information Base (LFIB), and one or more adjacency structures) on the ND forwarding plane 926. For layer 2 forwarding, the ND can store one or more bridging tables that are used to forward data based on the layer 2 information in that data. While the above example uses the special-purpose network device 902, the same distributed approach 972 can be implemented on the general purpose network device 904 and the hybrid network device 906.

FIG. 9D illustrates that a centralized approach 974 (also known as software defined networking (SDN)) that decouples the system that makes decisions about where traffic is sent from the underlying systems that forwards traffic to the selected destination. The illustrated centralized approach 974 has the responsibility for the generation of reachability and forwarding information in a centralized control plane 976 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 976 has a south bound interface 982 with a data plane 980 (sometime referred to the infrastructure layer, network forwarding plane, or forwarding plane (which should not be confused with a ND forwarding plane)) that includes the NEs 970A-H (sometimes referred to as switches, forwarding elements, data plane elements, or nodes). The centralized control plane 976 includes a network controller 978, which includes a centralized reachability and forwarding information module 979 that determines the reachability within the network and distributes the forwarding information to the NEs 970A-H of the data plane 980 over the south bound interface 982 (which may use the OpenFlow protocol). Thus, the network intelligence is centralized in the centralized control plane 976 executing on electronic devices that are typically separate from the NDs.

For example, where the special-purpose network device 902 is used in the data plane 980, each of the control communication and configuration module(s) 932A-R of the ND control plane 924 typically include a control agent that provides the VNE side of the south bound interface 982. In this case, the ND control plane 924 (the processor(s) 912 executing the control communication and configuration module(s) 932A-R) performs its responsibility for participating in controlling how data (e.g., packets) is to be routed (e.g., the next hop for the data and the outgoing physical NI for that data) through the control agent communicating with the centralized control plane 976 to receive the forwarding information (and in some cases, the reachability information) from the centralized reachability and forwarding information module 979 (it should be understood that in some embodiments of the invention, the control communication and configuration module(s) 932A-R, in addition to communicating with the centralized control plane 976, may also play some role in determining reachability and/or calculating forwarding information—albeit less so than in the case of a distributed approach; such embodiments are generally considered to fall under the centralized approach 974, but may also be considered a hybrid approach).

While the above example uses the special-purpose network device 902, the same centralized approach 974 can be implemented with the general purpose network device 904 (e.g., each of the VNE 960A-R performs its responsibility for controlling how data (e.g., packets) is to be routed (e.g., the next hop for the data and the outgoing physical NI for that data) by communicating with the centralized control plane 976 to receive the forwarding information (and in some cases, the reachability information) from the centralized reachability and forwarding information module 979; it should be understood that in some embodiments of the invention, the VNEs 960A-R, in addition to communicating with the centralized control plane 976, may also play some role in determining reachability and/or calculating forwarding information—albeit less so than in the case of a distributed approach) and the hybrid network device 906. In fact, the use of SDN techniques can enhance the NFV techniques typically used in the general purpose network device 904 or hybrid network device 906 implementations as NFV is able to support SDN by providing an infrastructure upon which the SDN software can be run, and NFV and SDN both aim to make use of commodity server hardware and physical switches.

FIG. 9D also shows that the centralized control plane 976 has a north bound interface 984 to an application layer 986, in which resides application(s) 988. The centralized control plane 976 has the ability to form virtual networks 992 (sometimes referred to as a logical forwarding plane, network services, or overlay networks (with the NEs 970A-H of the data plane 980 being the underlay network)) for the application(s) 988. Thus, the centralized control plane 976 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

The functions of the pose predictor 981 and similar components can be stored as code at the electronic devices implementing the centralized control plane 976 and application layer 986. The pose predictor 981 can be part of the application 988, network controller 978 or similar elements. The pose predictor 981 and similar components can be executed by the processors of the electronic devices to perform the functions of the server application or XR device as described herein.

While FIG. 9D shows the distributed approach 972 separate from the centralized approach 974, the effort of network control may be distributed differently or the two combined in certain embodiments of the invention. For example: 1) embodiments may generally use the centralized approach (SDN) 974, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 974 but may also be considered a hybrid approach.

While FIG. 9D illustrates the simple case where each of the NDs 900A-H implements a single NE 970A-H, it should be understood that the network control approaches described with reference to FIG. 9D also work for networks where one or more of the NDs 900A-H implement multiple VNEs (e.g., VNEs 930A-R, VNEs 960A-R, those in the hybrid network device 906). Alternatively, or in addition, the network controller 978 may also emulate the implementation of multiple VNEs in a single ND. Specifically, instead of (or in addition to) implementing multiple VNEs in a single ND, the network controller 978 may present the implementation of a VNE/NE in a single ND as multiple VNEs in the virtual networks 992 (all in the same one of the virtual network(s) 992, each in different ones of the virtual network(s) 992, or some combination). For example, the network controller 978 may cause an ND to implement a single VNE (a NE) in the underlay network, and then logically divide up the resources of that NE within the centralized control plane 976 to present different VNEs in the virtual network(s) 992 (where these different VNEs in the overlay networks are sharing the resources of the single VNE/NE implementation on the ND in the underlay network).

On the other hand, FIGS. 9E and 9F respectively illustrate exemplary abstractions of NEs and VNEs that the network controller 978 may present as part of different ones of the virtual networks 992. FIG. 9E illustrates the simple case of where each of the NDs 900A-H implements a single NE 970A-H (see FIG. 9D), but the centralized control plane 976 has abstracted multiple of the NEs in different NDs (the NEs 970A-C and G-H) into (to represent) a single NE 970I in one of the virtual network(s) 992 of FIG. 9D, according to some embodiments of the invention. FIG. 9E shows that in this virtual network, the NE 970I is coupled to NE 970D and 970F, which are both still coupled to NE 970E.

FIG. 9F illustrates a case where multiple VNEs (VNE 970A.1 and VNE 970H.1) are implemented on different NDs (ND 900A and ND 900H) and are coupled to each other, and where the centralized control plane 976 has abstracted these multiple VNEs such that they appear as a single VNE 970T within one of the virtual networks 992 of FIG. 9D, according to some embodiments of the invention. Thus, the abstraction of a NE or VNE can span multiple NDs.

While some embodiments of the invention implement the centralized control plane 976 as a single entity (e.g., a single instance of software running on a single electronic device), alternative embodiments may spread the functionality across multiple entities for redundancy and/or scalability purposes (e.g., multiple instances of software running on different electronic devices).

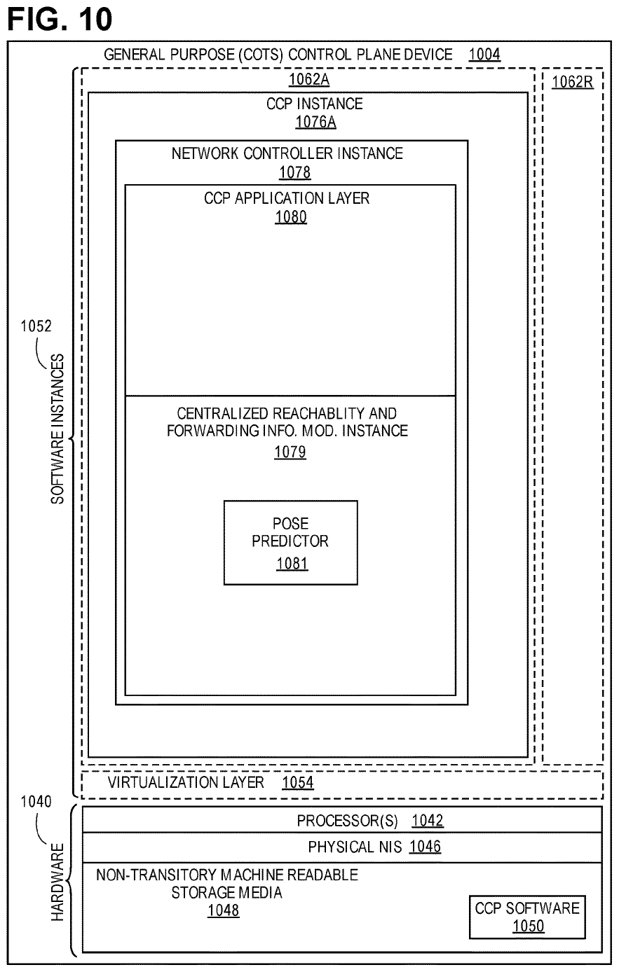

Similar to the network device implementations, the electronic device(s) running the centralized control plane 976, and thus the network controller 978 including the centralized reachability and forwarding information module 979, may be implemented a variety of ways (e.g., a special purpose device, a general-purpose (e.g., COTS) device, or hybrid device). These electronic device(s) would similarly include processor(s), a set of one or more physical NIs, and a non-transitory machine-readable storage medium having stored thereon the centralized control plane software. For instance, FIG. 10 illustrates, a general purpose control plane device 1004 including hardware 1040 comprising a set of one or more processor(s) 1042 (which are often COTS processors) and physical NIs 1046, as well as non-transitory machine readable storage media 1048 having stored therein centralized control plane (CCP) software 1050.

The functions of the pose predictor 1081 and similar components can be stored as code in the non-transitory machine readable storage media 1048 as part of the CCP instance 1076A-R or similar software. The pose predictor 1081 and similar components can be executed by the processors 1042 to perform the functions of the server application or XR device as described herein.

In embodiments that use compute virtualization, the processor(s) 1042 typically execute software to instantiate a virtualization layer 1054 (e.g., in one embodiment the virtualization layer 1054 represents the kernel of an operating system (or a shim executing on a base operating system) that allows for the creation of multiple instances 1062A-R called software containers (representing separate user spaces and also called virtualization engines, virtual private servers, or jails) that may each be used to execute a set of one or more applications; in another embodiment the virtualization layer 1054 represents a hypervisor (sometimes referred to as a virtual machine monitor (VMM)) or a hypervisor executing on top of a host operating system, and an application is run on top of a guest operating system within an instance 1062A-R called a virtual machine (which in some cases may be considered a tightly isolated form of software container) that is run by the hypervisor; in another embodiment, an application is implemented as a unikernel, which can be generated by compiling directly with an application only a limited set of libraries (e.g., from a library operating system (LibOS) including drivers/libraries of OS services) that provide the particular OS services needed by the application, and the unikernel can run directly on hardware 1040, directly on a hypervisor represented by virtualization layer 1054 (in which case the unikernel is sometimes described as running within a LibOS virtual machine), or in a software container represented by one of instances 1062A-R). Again, in embodiments where compute virtualization is used, during operation an instance of the CCP software 1050 (illustrated as CCP instance 1076A) is executed (e.g., within the instance 1062A) on the virtualization layer 1054. In embodiments where compute virtualization is not used, the CCP instance 1076A is executed, as a unikernel or on top of a host operating system, on the “bare metal” general purpose control plane device 1004. The instantiation of the CCP instance 1076A, as well as the virtualization layer 1054 and instances 1062A-R if implemented, are collectively referred to as software instance(s) 1052.

In some embodiments, the CCP instance 1076A includes a network controller instance 1078. The network controller instance 1078 includes a centralized reachability and forwarding information module instance 1079 (which is a middleware layer providing the context of the network controller 978 to the operating system and communicating with the various NEs), and an CCP application layer 1080 (sometimes referred to as an application layer) over the middleware layer (providing the intelligence required for various network operations such as protocols, network situational awareness, and user-interfaces). At a more abstract level, this CCP application layer 1080 within the centralized control plane 976 works with virtual network view(s) (logical view(s) of the network) and the middleware layer provides the conversion from the virtual networks to the physical view.

The centralized control plane 976 transmits relevant messages to the data plane 980 based on CCP application layer 1080 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers. Different NDs/NEs/VNEs of the data plane 980 may receive different messages, and thus different forwarding information. The data plane 980 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 980, the packet (or a subset of the packet header and content) is typically forwarded to the centralized control plane 976. The centralized control plane 976 will then program forwarding table entries into the data plane 980 to accommodate packets belonging to the flow of the unknown packet. Once a specific forwarding table entry has been programmed into the data plane 980 by the centralized control plane 976, the next packet with matching credentials will match that forwarding table entry and take the set of actions associated with that matched entry.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method of an extended reality (XR) application executed at a server, the method comprising:
receiving brain machine interface (BMI) data encoding brain signaling metrics from an XR device;
receiving position data from the XR device;
computing a pose prediction for a future time frame for the XR device using the BMI data and the position data;
computing an XR pre-frame for the future time frame using the pose prediction; and
sending the XR pre-frame to the XR device.

2. The method of claim 1, further comprising:
computing a low resolution XR frame for a current time frame in response to receiving the BMI data and position data; and
computing the XR pre-frame as a high resolution XR frame.

3. The method of claim 1, wherein the BMI data is magneto-encephalography or electro-encephalography data.

4. The method of claim 1, further comprising:
determining whether the XR application has sufficient historical information for predicting a pose position.

5. The method of claim 1, wherein an XR pre-frame prediction can be 20 milliseconds in future relative to a current XR frame.

6. (canceled)

7. An electronic device comprising:
a machine-readable storage medium having stored therein an application; and
a processor to execute the application to perform operations to cause the electronic device to:
receive brain machine interface (BMI) data encoding brain signaling metrics from an XR device;
receive position data from the XR device;
compute a pose prediction for a future time frame for the XR device using the BMI data and the position data;
compute an XR pre-frame for the future time frame using the pose prediction; and
send the XR pre-frame to the XR device.

8. A method of an extended reality (XR) device, the method comprising:
sending brain machine interface (BMI) data encoding brain signaling metrics to a server application;
sending position data to the server application;
receiving an XR pre-frame for a predicted pose of the XR device;
determining whether a current pose matches the predicted pose; and
rendering the XR pre-frame in response to the current pose matching the predicted pose.

9. The method of claim 8, wherein the BMI data is magneto-encephalography or electro-encephalography data.

10. The method of claim 8, further comprising:
determining whether the XR pre-frame for a current time has been received from the server application.

11. The method of claim 8, further comprising:
waiting for an XR frame to be received where the XR pre-frame has not been received; and
rendering the XR frame upon receipt from the server application.

12. The method of claim 8, wherein an XR pre-frame prediction can be 20 milliseconds in future relative to a current XR frame.

13. (canceled)

14. An electronic device comprising:
a machine-readable storage medium having stored therein an application; and
a processor to execute the application to perform operations to cause the electronic device to:
send brain machine interface (BMI) data encoding brain signaling metrics to a server application;
send position data to the server application;
receive an XR pre-frame for a predicted pose;
determine whether a current pose matches the predicted pose; and
render the XR pre-frame in response to the current pose matching the predicted pose.

15. The electronic device of claim 14, wherein the BMI data is magneto-encephalography or electro-encephalography data.

16. The electronic device of claim 14, further to:
determine whether the XR pre-frame for a current time has been received from the server application.

17. The electronic device of claim 14, further to:
wait for an XR frame to be received where the XR pre-frame has not been received; and
render the XR frame upon receipt from the server application.

18. The electronic device of claim 14, wherein an XR pre-frame prediction can be 20 milliseconds in future relative to a current XR frame.

19. The electronic device of claim 7, further to:
compute a low resolution XR frame for a current time frame in response to a receipt of the BMI data and position data; and
compute the XR pre-frame as a high resolution XR frame.

20. The electronic device of claim 7, wherein the BMI data is magneto-encephalography or electro-encephalography data.

21. The electronic device of claim 7, further to:
determine whether the application has sufficient historical information for predicting a pose position.

22. The electronic device of claim 7, wherein an XR pre-frame prediction can be 20 milliseconds in future relative to a current XR frame.
